(19) United States
(12) Patent Application Publication
(10) Pub. No.: US 2026/0277958 A1
(43) Pub. Date: Sep. 17, 2026

(54) TEXT GENERATION METHOD, COMPUTER DEVICE, AND STORAGE MEDIUM

(71) Applicant: Beijing Zitiao Network Technology Co., Ltd., Beijing (CN)

(72) Inventors: Zijie LIN, Beijing (CN); Jian LIAO, Beijing (CN); Huiyu MAI, Beijing (CN); Gang BAI, Beijing (CN); Mingke SONG, Beijing (CN); Xiaodong LI, Beijing (CN)

(21) Appl. No.: 19/570,037

(22) Filed: Mar. 17, 2026

(30) Foreign Application Priority Data
Mar. 17, 2025 (CN) 2025103155093

(51) Int. Cl. G06F 16/3329; G06F 16/334; G06F 40/30; G06V 30/414

(52) U.S. Cl. CPC G06F 16/33295; G06F 16/334; G06F 40/30; G06V 30/414

(57) ABSTRACT

The present disclosure provides a text generation method, a computer device, and a storage medium. The method includes: obtaining an initial text; performing information retrieval according to the initial text to obtain at least one piece of reference content; performing information extraction on the at least one piece of reference content using a first language model to generate at least one piece of extracted information; and in response to receiving a selection operation for the at least one piece of extracted information, generating a text outline according to selected extracted information, and performing text generation using a second language model according to the initial text and the text outline to obtain a target text.

### CROSS-REFERENCE

The present application claims priority to Chinese Patent Application No. 202510315509.3, filed on Mar. 17, 2025, which is incorporated herein by reference in its entirety as a part of the present application.

### TECHNICAL FIELD

The present disclosure relates to the field of computer technologies, and in particular, to a text generation method, a computer device, and a storage medium.

### BACKGROUND

The text generation task is an important component of natural language processing tasks, and text generation is required in some business scenarios, such as news, reports, or articles.

In related solutions, a large language model (LLM) may usually be used to participate in the text generation task to obtain a desired text, which may effectively implement the text generation task.

However, the large language model generally has a long training time, which leads to a time limitation on training data, which in turn makes it difficult for the generated text to contain relatively new or real-time information, making it difficult for the generated text to meet requirements in some scenarios, resulting in a poor user experience.

It should be noted that the information disclosed in the above background section is only for enhancing the understanding of the background of the present disclosure, and therefore may include information that does not constitute prior art known to those skilled in the art.

### SUMMARY

In view of this, the present disclosure provides a text generation method and apparatus, a computer device, and a storage medium to solve or partially solve the above problems.

Based on the above objective, a first aspect of the present disclosure provides a text generation method, including:
obtaining an initial text;
performing information retrieval according to the initial text to obtain at least one piece of reference content;
performing information extraction on the at least one piece of reference content using a first language model to generate at least one piece of extracted information; and
in response to receiving a selection operation for the at least one piece of extracted information, generating a text outline according to selected extracted information, and performing text generation using a second language model according to the initial text and the text outline to obtain a target text.

A second aspect of the present disclosure provides a text generation apparatus, including:
a first module configured to obtain an initial text;
a second module configured to perform information retrieval according to the initial text to obtain at least one piece of reference content;
a third module configured to perform information extraction on the at least one piece of reference content using a first language model to generate at least one piece of extracted information; and
a fourth module configured to: in response to receiving a selection operation for the at least one piece of extracted information, generate a text outline according to selected extracted information, and perform text generation using a second language model according to the initial text and the text outline to obtain a target text.

A third aspect of the present disclosure provides a computer device, including a memory, a processor, and a computer program stored in the memory and executable by the processor, where the computer program, when executed by the processor, causes the text generation method according to the first aspect to be implemented.

A fourth aspect of the present disclosure provides a non-transitory computer-readable storage medium storing computer instructions, where the computer instructions are used to cause a computer to perform the text generation method according to the first aspect.

It may be seen from the above descriptions that according to the text generation method and apparatus, the computer device, and the storage medium provided in the present disclosure, after an initial text is obtained, information retrieval is first performed by using the initial text, so that some relevant hot or real-time information may be obtained from the Internet or an internal information library, and reference content is formed based on the relevant hot or real-time information; thereafter, information extraction is performed based on the reference content, and a first language model may be used to divide obtained extracted information into a plurality of types according to different topics; then, desired information is determined through a corresponding selection operation, and a text outline is formed based on the desired information; and finally, a target text is generated by using the initial text and the text outline. In this case, the target text may contain real-time information, and may further contain content corresponding to different topics according to different selections based on the real-time information. In this way, on the basis that information collection efficiency and information timeliness of the generated target text are satisfied, the timeliness information may further be divided into different topics, so that an effect of a text generation model and user experience are improved.

### BRIEF DESCRIPTION OF DRAWINGS

To describe the technical solutions in the embodiments of the present disclosure or in the related art more clearly, the following briefly introduces drawings required for describing the embodiments or the related art. Apparently, the drawings in the following description show merely some embodiments of the present disclosure, and a person of ordinary skill in the art may still derive other drawings from these drawings without creative efforts.

FIG. 1 is a schematic diagram of an exemplary system 100 according to an embodiment of the present disclosure.

FIG. 2 is a schematic flowchart of an exemplary method 200 according to an embodiment of the present disclosure.

FIG. 3 is a schematic flowchart of a specific process of the exemplary method 200 in a specific scenario according to an embodiment of the present disclosure.

FIG. 4 is a schematic diagram of an exemplary apparatus 400 according to an embodiment of the present disclosure.

FIG. 5 is a schematic diagram of an exemplary computer device 500 according to an embodiment of the present disclosure.

### DETAILED DESCRIPTION

In order to make the purpose, technical solutions and advantages of this specification clearer, the specification will be further described in detail below in combination with specific embodiments and with reference to the drawings.

It should be noted that unless otherwise defined, the technical or scientific terms used in the embodiments of the present disclosure shall have the ordinary meanings as understood by those of ordinary skill in the art to which the present disclosure belongs. “First”, “second” and like words used in the examples of the present disclosure do not represent any order, quantity or importance, but are only used to distinguish between different components. “Include” or “include” or like words mean that an element or item preceding the term encompasses an element or item or its equivalent listed after the term, without excluding other elements or items. “Connect” or “connected” or like words are not limited to a physical or mechanical connection, but may include an electrical connection, whether direct or indirect. “Up”, “down”, “left”, “right”, etc. are only used to represent a relative positional relationship, and when an absolute position of the described object changes, the relative positional relationship may also change accordingly.

It may be understood that before using the technical solutions disclosed in the embodiments of the present disclosure, the user shall be informed of the type, range of use, use scenarios, etc. of personal information involved in the present disclosure and obtain the authorization of the user in an appropriate manner in accordance with relevant laws and regulations.

For example, in response to receiving an active request from a user, prompt information is sent to the user to clearly prompt the user that the requested operation will require access to and use of the user's personal information. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure, and other methods that satisfy the relevant laws and regulations may also be applied to the implementations of the present disclosure.

It may be understood that the data involved in the technical solution (including but not limited to the data itself, acquisition or use of the data) shall comply with requirements of corresponding laws, regulations and related provisions.

In order to make the purpose, technical solutions and advantages of this specification clearer, the specification will be further described in detail below in combination with specific embodiments and with reference to the drawings.

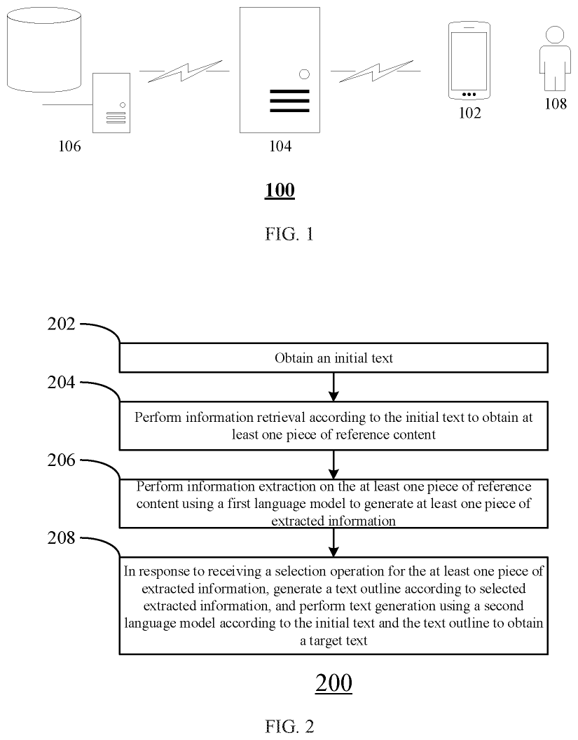

FIG. 1 is a schematic diagram of an exemplary system 100 according to an embodiment of the present disclosure. The system 100 may be a system for implementing text generation.

As shown in FIG. 1, taking a terminal device and a server jointly performing the object display method as an example, the system 100 may include a terminal device 102, a server 104, and a database server 106. The terminal device 102 and the server 104 are connected to each other through a network, for example, through a wired or wireless network. Optionally, an apparatus for implementing text generation may be integrated in the terminal device 102. The database server 106 and the server 104 are connected to each other through a network, for example, through a wired or wireless network. The database server 106 may store various data related to the execution of the text generation method, such as a basic text framework, a grammatical structure, a text generation algorithm, and so on.

The terminal device 102 may be installed thereon various applications (abbreviated as “APP”), such as a text processing application, a video conference application, a life service application, a reading application, a video application, a social application, a payment application, a web browser, and an instant messaging tool, which may all be used for text generation and/or displaying the generated text. As an optional example, the application (APP) installed on the terminal device 102 may be downloaded from the server 104 and installed.

The terminal device 102 here may be hardware or software. When the terminal device 102 is hardware, it may be various electronic devices having a display screen, including but not limited to a smart phone, a tablet computer, an e-book reader, an MP3 player, a laptop portable computer (Laptop), and a desktop computer (PC), etc. When the terminal device 102 is software, it may be installed in the electronic devices listed above. It may be implemented as a plurality of pieces of software or software modules (for example, for providing distributed services), or may be implemented as a single piece of software or a single software module. It is not particularly limited herein.

The server 104 may be a server that provides various services, such as a background server that provides support for various applications displayed on the terminal device 102. The database server 106 may also be a database server that provides various services. It may be understood that in the case that the server 104 may implement the related functions of the database server 106, the system 100 may not be provided with the database server 106.

The server 104 and the database server 106 here may also be hardware or software. When they are hardware, they may be implemented as a distributed server cluster composed of a plurality of servers, or as a single server. When they are software, they may be implemented as a plurality of pieces of software or software modules (for example, for providing distributed services), or as a single piece of software or a single software module. It is not particularly limited herein.

It should be noted that the text generation method provided by the embodiments of the present disclosure may be performed by the system 100, and specifically, may be performed by interaction among the terminal device 102, the server 104, and the database server 106. It may be understood that in the case that the terminal device 102 has the functions required by the server 104 and the database server 106 to perform the text generation method, it may also be performed by the terminal device 102 alone. It should be understood that the numbers of the terminal device 102, the server 104, the database server 106, and the user 108 in FIG. 1 are merely illustrative. There may be any number of terminal devices, users, servers, and database servers according to actual needs.

In an exemplary application scenario, the user 108 may input an instruction for creating a text through the terminal device 102, and the server 104 may provide a text generation service for the user 108 based on the instruction, and display an operation interface of the text generation service on a page through the terminal device 102.

As described in the background section, in some examples, the user may use artificial intelligence (AI) to perform text generation, for example, by using a large language model (LLM). Text generation refers to generating a new text copy through a computer algorithm and model.

In some examples, the text generation tool may be software or a program having a text generation function. However, it is not particularly limited herein. Specifically, any tool that has text generation capability and completes intelligent text generation through interaction with an operator may be considered as a text generation tool.

In a more specific scenario, the user 108 may use a text processing application (Application, APP) to generate a text copy by using a large language model. In a process of creating the text copy, especially a news copy or a real-time dynamic copy, the user needs to search for relevant knowledge and information by using a search engine or a general AI question answering tool, and then manually extract key information, and supplement the key information into the copy content, or use the key information as an outline of the copy. This process incurs high labor costs and has high requirements for retrieval skills.

In some examples, when using the AI-driven copy generation function, due to a time limitation on training data of the large language model (LLM), the model often performs poorly in responding to information-based topics, and may not be able to provide the most timely and accurate information, especially when it comes to the latest hot events and real-time dynamics. In addition, due to the limitation of the training data, the model may have defects in understanding and generation capabilities for some specific fields or professional knowledge. As a result, in some specific scenarios, the timeliness and professionalism of the generated text copy are poor, affecting the quality of the copy and resulting in a poor user experience.

In view of the above actual situation, the embodiments of the present disclosure provide a text generation method. In the method, after an initial text is obtained, information retrieval is first performed by using the initial text, so that some relevant hot or real-time information may be obtained from the Internet or an internal information library, and reference content is formed based on the relevant hot or real-time information; thereafter, information extraction is performed based on the reference content, and a first language model may be used to divide obtained extracted information into a plurality of types according to different topics; then, desired information is determined through a corresponding selection operation, and a text outline is formed based on the desired information; and finally, a target text is generated by using the initial text and the text outline. In this case, the target text may contain real-time information, and may further contain content corresponding to different topics according to different selections based on the real-time information. In this way, on the basis that information collection efficiency and information timeliness of the generated target text are satisfied, the timeliness information may further be divided into different topics, so that an effect of a text generation model and user experience are improved.

FIG. 2 is a schematic flowchart of an exemplary method 200 according to an embodiment of the present disclosure. Optionally, the method 200 may be used to generate a text, and in particular, may be used to generate a text with relatively strong real-time performance or professionalism. The method 200 may be performed by the terminal device 102 in FIG. 1, or by the system 100 in FIG. 1.

As shown in FIG. 2, the text generation method exemplarily provided in the embodiment of the present disclosure may specifically include the following steps.

Step 202: obtaining an initial text.

In this step, the initial text is initial data for text generation, and the text here may be provided by the user through a corresponding port when using the text generation tool, or may be imported in batch through a table or a link. In some examples, the user 108 may use the terminal device 102 to upload the initial text to the text generation tool of the server 104, or the user 108 may control, through an operation on the terminal device 102, the text generation tool of the server 104 to obtain the initial text from a corresponding channel. Certainly, in some other examples, the user 108 may further use the terminal device 102 to obtain the corresponding initial text from the server 104. However, this is not specifically limited in this example.

Thereafter, the initial text may contain some requirements for the to-be-generated text, such as a topic, a focus, a time interval, and an object of the generated text. The initial text may be a piece of text description or a plurality of keywords and phrases, and may further set rules to be followed for the generated text as needed. All of these may be obtained at one time, or may be obtained by using different ports or the like for a plurality of times.

Step 204: performing information retrieval according to the initial text to obtain at least one piece of reference content.

In this step, after the initial text is obtained, the content in the initial text may be used for retrieval. Some information related to the initial text may be searched for on the Internet, in an external database, or in an internal database. For example, real-time or recent news reports related to the content mentioned in the initial text may be determined on the Internet, or content related to a professional term mentioned in the initial text may be searched for on the Internet or in a professional database. Thereafter, the retrieved content may be used as one piece of reference content, or information extraction may be performed based on the retrieved content, and the extracted content may be used as one piece of reference content.

In some examples, for a manner of performing information retrieval using the initial text, information extraction may be performed on the initial text to form at least one search term. For example, a search term extraction technology may be used to convert the provided initial text into a search term that is more in line with a search engine. In some other examples, semantic summarization may further be performed on the initial text to form semantic information corresponding to the initial text, and then the semantic information may be used to perform search engine retrieval. Certainly, in some specific scenarios, search term retrieval and semantic retrieval may be combined for use, to implement more accurate information retrieval. That is, in some examples, the performing information retrieval according to the initial text includes: determining at least one first search term in the initial text, and performing the information retrieval according to the at least one first search term; and/or determining first semantic information of the initial text, and performing the information retrieval according to the first semantic information.

Thereafter, at least one piece of relevant information, such as a relevant article, news, or even forum content, may be obtained by using a corresponding retrieval manner. Here, the retrieved information may be collectively referred to as an intermediate article. Thereafter, in some examples, these articles may be directly used as the final reference content. If higher requirements are imposed on the reference content, information extraction needs to be performed on the reference content, to remove irrelevant and poorly relevant content therefrom, and only retain content with a high degree of relevance and better meet user needs. Here, a corresponding information extraction technology may be used to perform information extraction on the intermediate article, for example, remove some adjectives, connecting sentences, background description, guiding statements, etc., to perform information summarization on the intermediate article, thereby forming one piece of reference content.

In some other examples, to facilitate or complete information summarization of the intermediate article as soon as possible and improve efficiency, the intermediate article may be segmented, for example, segmented according to a set length, and then a similarity between each piece of information and the search term and/or the semantic information mentioned above is determined. A higher similarity indicates that this piece of information is more relevant to the search term and/or the semantic information. Thereafter, sorting and screening may be performed according to the similarity of each piece of information, for example, several pieces of information with the highest similarity are selected. Therefore, the intermediate article may be summarized as content composed of several pieces of information, to complete information extraction of the intermediate article. Certainly, in order to make the content in the article expressed smoothly, several pieces of selected information may be supplemented by means of nearest neighbor search, for example, contextual information, so as to obtain the final reference content. Specifically, after a plurality of relevant documents are retrieved by calling the search engine, an abstract with the highest association with the topic in each document may be obtained by means of an automatic extraction technology, and the abstract may be used to form the reference content on behalf of the document. Specifically for abstract extraction: the text of the relevant document may be divided into blocks according to a fixed length, the blocks are sorted according to a similarity between the blocks and the search term and/or the semantic information, several blocks with the highest similarity are selected as seed blocks, and sentences are supplemented by means of nearest neighbor search, so as to obtain the final abstract. That is, in some examples, the obtaining at least one piece of reference content includes: obtaining at least one intermediate article according to a result of the information retrieval, and segmenting any intermediate article to obtain at least one segmented block; determining a similarity between the at least one segmented block and the at least one first search term and/or the first semantic information, and screening the at least one segmented block according to the similarity; and supplementing and combining results of the screening to obtain one piece of reference content. The segmented block may correspond to any piece of information obtained after the intermediate article is segmented.

In a more specific application scenario, a manner of determining the similarity between the segmented block and the search term and/or the semantic information may be determined by means of an Embedding similarity calculation method. The Embedding similarity refers to measuring similarity between data by converting the data into a vector form and calculating similarity between the vectors. Specifically, the similarity may be determined by using a Euclidean distance, an inner product, cosine similarity, or the like. Specifically, in some examples, a vector representation corresponding to the segmented block, a vector representation corresponding to the search term, and/or a vector representation corresponding to the semantic information may be determined, and then a distance between the vector representations is determined by using the cosine similarity or the like, and the distance may be regarded as a similarity score. That is, in some examples, the determining a similarity between the at least one segmented block and the at least one first search term and/or the first semantic information includes: determining vector representations of the at least one segmented block, the at least one first search term, and/or the first semantic information, respectively, and determining cosine similarity between the vector representations to determine the similarity.

In some examples, to facilitate determining a source of each piece of reference content, when the reference content is formed, the source of the reference content may be managed as an identification together with the reference content. For example, a source address of the reference content is identified on the reference content, so that the user may determine the source of the reference content based on the identification when viewing the reference content or information formed based on the reference content. That is, in some examples, the obtaining at least one piece of reference content includes: determining a source address of any piece of reference content, and generating a source identification for the any piece of reference content based on the source address.

Step 206: performing information extraction on the at least one piece of reference content using a first language model to generate at least one piece of extracted information.

In this step, the first language model may be the whole or part of the large language model LLM mentioned above. The first language model may be used to summarize the at least one piece of reference content, and output the summary in a trained format to form a plurality of pieces of extracted information. One piece of reference content may form a plurality of pieces of extracted information, or may be used to form a plurality of pieces of extracted information.

In some examples, each piece of extracted information may generally correspond to one title, and one title may include a plurality of pieces of extracted information. For example, a plurality of pieces of news related to content A are found, and a plurality of pieces of reference content are formed. The first language model may be used to separately summarize an event overview, event details, background information, future plans, and the like of the content A. The event overview, the event details, the background information, the future plans, and the like herein are titles, and at least one piece of extracted information may be formed under each title through different pieces of reference content. The same piece of extracted information may be derived from only one piece of reference content, or may be derived from a plurality of pieces of reference content. The first language model that is trained in advance may be used for this purpose. During a training process of the first language model, the few-shot learning capability of the large language model LLM may further be used, and high-quality manually labeled samples may be used to synthesize content summary data for Internet retrieval, to train the first language model. Certainly, to facilitate determining a source of each piece of extracted information, on the basis of the source identification for the reference content mentioned above, source identification may also be performed on the extracted information, and the identification may be inherited from the source identification of the reference content. That is, in some examples, the performing information extraction on the at least one piece of reference content using the first language model includes: using the first language model to perform content extraction of at least one set title on the at least one piece of reference content, and performing source identification on content extracted for each set title, to complete the information extraction.

Thereafter, after the plurality of pieces of extracted information are obtained, the pieces of extracted information may be displayed in a set format. For example, the pieces of extracted information may be arranged and displayed according to the different titles mentioned above. Thereafter, the user may select from the displayed extracted information. If a selection is made, the subsequent step 208 may be performed, and the text outline is generated based on the selected extracted information.

In some other examples, if the user is not satisfied with the displayed titles or extracted information, or has other requirements to consider, the user may not select the extracted information, but directly fill in and input corresponding information. Therefore, in this scenario, the text outline needs to be formed based on the user input information. That is, in some examples, after the at least one piece of extracted information is generated, the method further includes: in response to not receiving the selection operation for the at least one piece of extracted information, receiving text information; and generating the text outline based on the received text information. The text information herein may be text content corresponding to a text input operation performed by the user in this stage.

Further, since the text information is entered by the user or actively found by the user, a format of the text information is not fixed. To facilitate forming the text outline, and make the formed text outline similar to the text outline formed by selecting the extracted information mentioned above, after the text information is obtained, at least one content point in the text information may be first determined. The content point may be understood as the title mentioned above, and the content point herein may be determined according to a set framework. For example, a document generally includes background information, event details, an event overview, and the like, and these may be used as content points. Thereafter, for one content point, a corresponding search term and/or semantic information may be determined in the text information, and the determination process may be the same as or similar to the manner of determining the corresponding content in the initial text mentioned above. A plurality of relevant documents may be determined using the search term and/or the semantic information, and then these relevant documents are screened and subjected to content cropping, to obtain specific content corresponding to the content point. Therefore, the text outline may be formed based on the content points and the specific content of each content point. That is, in some examples, the generating the text outline based on the received text information includes: determining at least one content point in the text information; for any content point, determining at least one second search term and/or second semantic information based on the text information, and performing retrieval according to the at least one second search term and/or the second semantic information to obtain at least one relevant document; and performing document screening and content cropping on the at least one relevant document to obtain specific content corresponding to the any content point, to generate the text outline based on specific content corresponding to the at least one content point.

Thereafter, for the process of document screening, the relevant documents may also be sorted by using the similarity between the relevant documents and the search term and/or the semantic information, and then selection is performed according to certain rules. For example, several relevant documents with the highest similarity are selected to complete the document screening work. That is, in some examples, the performing document screening on the at least one relevant document includes: sorting the at least one relevant document according to a similarity between the at least one relevant document and the at least one second search term and/or the second semantic information, and selecting documents according to a first set rule to perform the document screening.

Thereafter, for the process of content cropping, after the document screening, for the relevant documents that pass the screening, similar to the foregoing embodiment, in some examples, these relevant documents may be divided according to a set length, and then a similarity between each divided segment and the search term and/or the semantic information is determined, and selection is performed according to certain rules. For example, several segments with the highest similarity are selected to complete the cropping of the content. Certainly, during specific implementation, the contextual information may further be used to supplement and adjust the cropped segments to make the segments smoother. That is, in some examples, the performing content cropping on the at least one relevant document includes: dividing any relevant document that passes the document screening according to a set length; and sorting at least one divided segment according to a similarity between the at least one divided segment and the at least one second search term and/or the second semantic information, and selecting segments according to a second set rule to perform the content cropping.

In some specific scenarios, if the selection operation for the at least one piece of extracted information is not received, the user generally manually enters an outline. Therefore, before copy generation, a search term extraction technology may be invoked to extract a plurality of search terms related to the content points from the content entered by the user; a search engine is invoked to search for a plurality of relevant documents; and then a heuristic algorithm is used to filter the documents recalled by different search terms and perform content cropping, to ensure that each key point has supplementary reference information. In a retrieval assistant, the retrieved documents are separately arranged and input to the LLM, and the content cropping is also performed only on the content of a single document. A specific strategy may be: document screening, where at least m documents are selected for each point, and the remaining documents are selected in a descending order of relevance; content cropping: at least m segments are selected from each document, and the remaining segments are selected in a descending order of relevance.

Step 208: in response to receiving a selection operation for the at least one piece of extracted information, generating a text outline according to selected extracted information, and performing text generation using a second language model according to the initial text and the text outline to obtain a target text.

In this step, if the user selects from the at least one piece of extracted information, the text outline may be generated according to a title corresponding to each piece of selected extracted information and the selected extracted information. In some more specific scenarios, a display format of the extracted information may be a format of the text outline. The selection operation here may be regarded as a deletion and adjustment operation for the text outline, in which unnecessary content is deleted, and required emphasis is determined. Thereafter, the target text may be generated by using the second language model according to the text outline and the initial text. The second language model here may also be the large language model LLM itself or a part thereof. A specific format of the generated target text may be determined through training in advance. For example, a piece of introduction information is first generated by using the initial text, and then a piece of real-time latest news is generated according to the text outline, to form the target text in combination. Certainly, the initial text and the text outline may be fused to generate content, or the initial text and the text outline may be separated, corresponding texts may be separately generated, and then the texts are combined to form the target text. That is, in some examples, the performing text generation using the second language model according to the initial text and the text outline includes: using the second language model to generate first content according to the initial text; using the second language model to perform content generation according to at least one content item listed in the text outline, to form second content; and combining the first content and the second content to complete the text generation.

Finally, the generated target text may be displayed and output on a corresponding apparatus to give corresponding feedback to an operator. Certainly, in some other examples, an output manner of the target text may not be limited to output display, and the target text may further be stored, displayed, used, or reprocessed. According to different application scenarios and implementation requirements, a specific output manner of the target text may be flexibly selected.

For example, for an application scenario in which the method in this example is performed on a single device, the target text may be directly output in a display manner on a display component (a display, a projector, or the like) of a current device, so that an operator of the current device may directly see content of the target text on the display component.

For another example, for an application scenario in which the method in this example is performed on a system including a plurality of devices, the target text may be sent to another preset device (that is, a synchronization terminal) that serves as a receiver in the system through any data communication manner (a wired connection, NFC, Bluetooth, Wi-Fi, a cellular mobile network, or the like), so that the synchronization terminal may perform subsequent processing on the target text. Optionally, the synchronization terminal may be a preset server. The server is generally disposed on a cloud and serves as a data processing and storage center, and may store and distribute the target text. A receiver of the distribution is a terminal device, and a holder or an operator of the terminal device may be an operator (user) of the text generation operation, a maintenance person of the text generation tool, a content supervisor of the text generation tool, and the like.

For still another example, when the method in this example is performed on a system including a plurality of devices, the target text may be directly sent to a preset terminal device through any data communication manner, and the terminal device may be one or more of those listed in the foregoing paragraph.

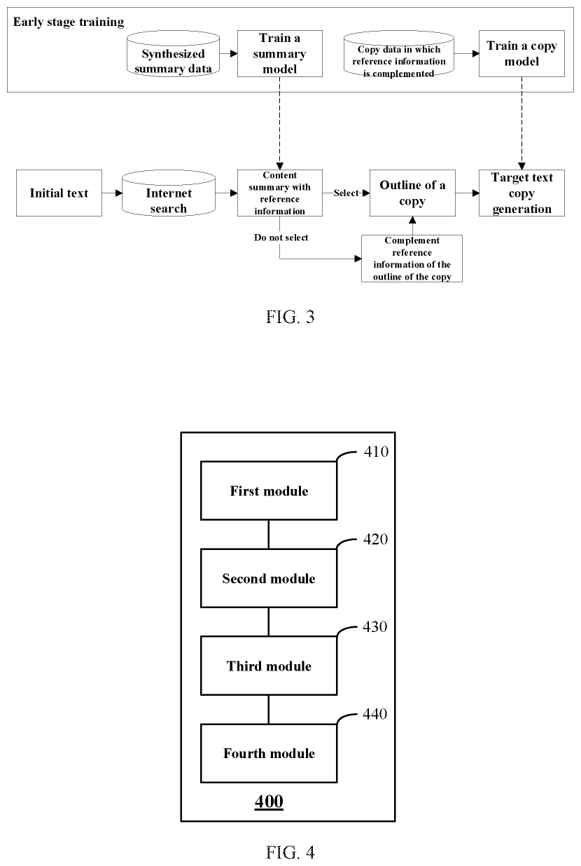

In a specific application scenario, as shown in FIG. 3, there is a method application process in a specific scenario. In the early stage, a summary model (the first language model) and a copy model (the second language model) may be separately trained. The summary model may be trained by using synthesized summary data, and the copy model may be trained by using copy data in which reference information (which may be the source identification) is complemented. During application, after the user inputs a corresponding initial text, Internet search is performed, and the searched content is input to the summary model, so that a content summary (which may be the extracted information) with reference information may be obtained. In this case, if the user makes a selection, the selected content may be filled in the outline of the copy. If no selection is made, the user generally enters corresponding content. In this case, the content may be automatically completed, and the reference information is determined. After the outline of the copy is formed, the outline of the copy is input to the copy model in combination with the user input, to finally complete generation of the target text copy.

It may be seen from the above embodiments that according to the text generation method provided in the embodiments of the present disclosure, after the initial text is obtained, information retrieval is first performed using the initial text, so that some relevant hot or real-time information may be obtained from the Internet or an internal information library, and the reference content is formed based on the relevant hot or real-time information; thereafter, information extraction is performed based on the reference content, and the first language model may be used to divide the obtained extracted information into a plurality of types according to different topics; then, desired information is determined through the corresponding selection operation, and the text outline is formed based on the desired information; and finally, the target text is generated by using the initial text and the text outline. In this case, the target text may contain real-time information, and may further contain content corresponding to different topics according to different selections based on the real-time information. In this way, on the basis that information collection efficiency and information timeliness of the generated target text are satisfied, the timeliness information may further be divided into different topics, so that an effect of a text generation model and user experience are improved.

It should be noted that the method in the embodiments of the present disclosure may be performed by a single device, such as a computer or a server. The method in the embodiments of the present disclosure may also be applied to a distributed scenario, and is completed by a plurality of devices in cooperation with each other. In the case of such a distributed scenario, one of the plurality of devices may perform only one or more steps of the method in the embodiments of the present disclosure, and the plurality of devices may interact with each other to complete the method.

It should be noted that the foregoing describes specific embodiments of the present disclosure. Other embodiments are within the scope of the appended claims. In some cases, the actions or steps recited in the claims may be performed in an order different from that in the foregoing embodiments and still achieve desired results. In addition, the processes depicted in the drawings do not necessarily require a specific order shown or a sequential order to achieve desired results. In some implementations, multitasking and parallel processing are also possible or may be advantageous.

Based on the same technical concept, the present disclosure further provides a text generation apparatus corresponding to the method in any one of the foregoing embodiments. FIG. 4 is a schematic diagram of an exemplary apparatus 400 according to an embodiment of the present disclosure. As shown in FIG. 4, the apparatus 400 may be used to implement the method 200, and may further include the following modules.

The first module 410 is configured to obtain an initial text.

The second module 420 is configured to perform information retrieval according to the initial text to obtain at least one piece of reference content.

The third module 430 is configured to perform information extraction on the at least one piece of reference content using a first language model to generate at least one piece of extracted information.

The fourth module 440 is configured to: in response to receiving a selection operation for the at least one piece of extracted information, generate a text outline according to selected extracted information, and perform text generation using a second language model according to the initial text and the text outline to obtain a target text.

In some exemplary embodiments, the second module 420 is further configured to:
determine at least one first search term in the initial text, and perform the information retrieval according to the at least one first search term;
and/or
determine first semantic information of the initial text, and perform the information retrieval according to the first semantic information.

In some exemplary embodiments, the second module 420 is further configured to:
obtain at least one intermediate article according to a result of the information retrieval, and segment any intermediate article to obtain at least one segmented block;
determine a similarity between the at least one segmented block and the at least one first search term and/or the first semantic information, and screen the at least one segmented block according to the similarity; and
supplement and combine results of the screening to obtain one piece of reference content.

In some exemplary embodiments, the second module 420 is further configured to:
determine vector representations of the at least one segmented block and the at least one first search term and/or the first semantic information, respectively, and determine cosine similarity between the vector representations to determine the similarity.

In some exemplary embodiments, the second module 420 is further configured to:
determine a source address of any piece of reference content, and generate a source identification for the any piece of reference content based on the source address.

In some exemplary embodiments, the third module 430 is further configured to:
receive text information in response to not receiving the selection operation for the at least one piece of extracted information; and
generate a text outline based on the received text information.

In some exemplary embodiments, the third module 430 is further configured to:
determine at least one content point in the text information;
for any content point, determine at least one second search term and/or second semantic information based on the text information, and perform retrieval according to the at least one second search term and/or the second semantic information to obtain at least one relevant document; and
perform document screening and content cropping on the at least one relevant document to obtain specific content corresponding to the any content point, to generate the text outline based on specific content corresponding to the at least one content point.

In some exemplary embodiments, the third module 430 is further configured to:
sort the at least one relevant document according to a similarity between the at least one relevant document and the at least one second search term and/or the second semantic information, and select documents according to a first set rule to perform the document screening.

In some exemplary embodiments, the third module 430 is further configured to:
divide any relevant document that passes the document screening according to a set length; and
sort at least one divided segment according to a similarity between the at least one divided segment and the at least one second search term and/or the second semantic information, and select segments according to a second set rule to perform the content cropping.

In some exemplary embodiments, the third module 430 is further configured to:
use the first language model to perform content extraction of at least one set title on the at least one piece of reference content, and perform source identification on content extracted for each set title, to complete the information extraction.

In some exemplary embodiments, the fourth module 440 is further configured to:
use the second language model to generate first content according to the initial text;
use the second language model to perform content generation according to at least one content item listed in the text outline, to form second content; and
combine the first content and the second content to complete the text generation.

For ease of description, when described, the above apparatus is divided into various modules based on functions. Certainly, during implementation of the present disclosure, the functions of the modules may be implemented in the same software and/or hardware or a plurality of pieces of software and/or hardware.

The apparatus in the above embodiments is configured to implement the corresponding method 200 in any one of the foregoing embodiments, and has the beneficial effects of the corresponding method 200 embodiments. Details are not described herein again.

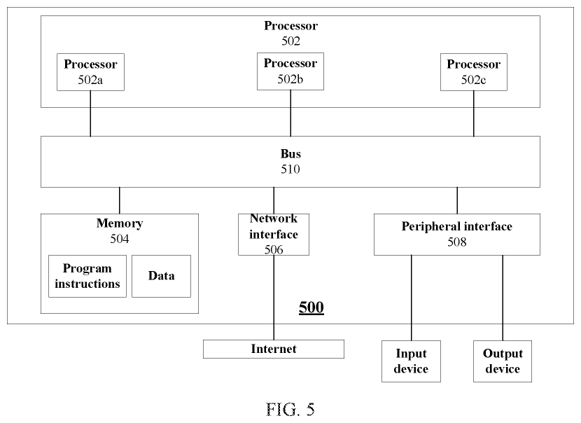

Based on the same technical concept, corresponding to the method in any one of the foregoing embodiments, an embodiment of the present disclosure further provides a computer device for implementing the foregoing method 200. FIG. 5 is a schematic diagram of a hardware structure of an exemplary computer device 500 according to an embodiment of the present disclosure. The computer device 500 may be used to implement the terminal device 102 in FIG. 1. In some scenarios, the computer device 500 may also be used to implement the server 104 and the database server 106 in FIG. 1.

As shown in FIG. 5, the computer device 500 may include a processor 502, a memory 504, a network interface 506, a peripheral interface 508, and a bus 510. The processor 502, the memory 504, the network interface 506, and the peripheral interface 508 are communicatively connected to each other within the computer device 500 through the bus 510.

The processor 502 may be a central processing unit (CPU), an image processor, a neural-network processing unit (NPU), a microcontroller unit (MCU), a programmable logic device, a digital signal processor (DSP), an application specific integrated circuit (ASIC), or one or more integrated circuits. The processor 502 may be configured to perform functions related to the technologies described in the present disclosure. In some embodiments, the processor 502 may further include a plurality of processors integrated into a single logic component. For example, as shown in FIG. 5, the processor 502 may include a plurality of processors 502a, 502b, and 502c.

The memory 504 may be configured to store data (for example, instructions, computer code, etc.). As shown in FIG. 5, the data stored in the memory 504 may include program instructions (for example, program instructions for implementing the method 200 in the embodiments of the present disclosure) and data to be processed (for example, the memory may store configuration files of other modules, etc.). The processor 502 may also access the program instructions and the data stored in the memory 504, and execute the program instructions to operate on the data to be processed. The memory 504 may include a volatile memory device or a non-volatile memory device. In some embodiments, the memory 504 may include a random access memory (RAM), a read-only memory (ROM), an optical disc, a magnetic disk, a hard disk, a solid-state drive (SSD), a flash memory, a memory stick, and the like.

The network interface 506 may be configured to provide, via a network, communication between the computer device 500 and other external devices. The network may be any wired or wireless network capable of transmitting and receiving data. For example, the network may be a wired network, a local wireless network (such as Bluetooth, Wi-Fi, or near-field communication (NFC)), a cellular network, the Internet, or a combination thereof. It may be understood that the type of the network is not limited to the above specific examples.

The peripheral interface 508 may be configured to connect the computer device 500 to one or more peripheral apparatuses to enable information input and output. For example, the peripheral apparatuses may include input devices such as a keyboard, a mouse, a touchpad, a touch screen, a microphone, and various sensors, and output devices such as a display, a speaker, a vibrator, and an indicator light.

The bus 510 may be configured to transfer information between components (for example, the processor 502, the memory 504, the network interface 506, and the peripheral interface 508) of the computer device 500, such as an internal bus (for example, a processor-memory bus), an external bus (a USB port, a PCI-E bus), and the like.

It should be noted that although only the processor 502, the memory 504, the network interface 506, the peripheral interface 508, and the bus 510 are shown in the architecture of the computer device 500, during a specific implementation, the architecture of the computer device 500 may further include other components necessary for proper operation. In addition, a person skilled in the art may understand that the architecture of the computer device 500 may include only the components necessary for implementing the solutions in the embodiments of the present disclosure, and not necessarily include all the components shown in the figure.

Based on the same technical concept, corresponding to the method in any one of the foregoing embodiments, the present disclosure further provides a non-transitory computer-readable storage medium storing computer instructions, where the computer instructions are used to cause a computer to perform the method 200 according to any one of the foregoing embodiments.

The computer-readable medium in this embodiment includes permanent and non-permanent, removable and non-removable media, and information storage may be implemented by using any method or technology. Information may be computer-readable instructions, data structures, program modules, or other data. Examples of the computer storage medium include but are not limited to a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette tape, tape or disk storage or another magnetic storage device, or any other non-transmission medium that may be used to store information that may be accessed by a computing device.

The computer instructions stored on the storage medium in the above embodiments are used to cause the computer to perform the method 200 according to any one of the foregoing embodiments, and have the beneficial effects of the corresponding method embodiments. Details are not described herein again.

Based on the same technical concept, corresponding to the method 200 according to any one of the foregoing embodiments, the present disclosure further provides a computer program product, including computer program instructions that, when executed on a computer, cause the computer to perform the method 200 according to any one of the foregoing embodiments. In some embodiments, the computer program instructions may be executed by one or more processors of the computer to cause the computer and/or the processor(s) to perform the method 200. Corresponding to the execution body corresponding to each step in each embodiment of the method 200, the processor that executes the corresponding step may belong to the corresponding execution body.

The computer program product in the above embodiments is used to cause the computer and/or the processor(s) to perform the method 200 according to any one of the foregoing embodiments, and has the beneficial effects of the corresponding method embodiments. Details are not described herein again.

It should be understood by those of ordinary skill in the art to which this invention belongs that the discussion of any one of the above embodiments is merely exemplary, and is not intended to imply that the scope of the present disclosure (including the claims) is limited to these examples; and with the concept of the present disclosure, the technical features in the above embodiments or different embodiments may also be combined, steps may be implemented in any order, many other changes may be made to different aspects of the embodiments of the present disclosure as described above and are not provided in detail for simplicity.

In addition, to simplify description and discussion and avoid obscuring an understanding of the embodiments of the present disclosure, well-known power/ground connections to an integrated circuit (IC) chip and other components may or may not be shown in the drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood by those skilled in the art). Where the specific details (e.g., circuitry) are set forth to describe the exemplary embodiments of the present disclosure, it will be apparent to those skilled in the art that the embodiments of the present disclosure may be implemented without these specific details or with variations to these specific details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the foregoing description. For example, the discussed embodiments may be used for other memory architectures such as a dynamic RAM (DRAM).

The embodiments of the present disclosure are intended to cover all such substitutions, modifications, and variations that fall within the broad scope of the appended claims. Therefore, any omissions, modifications, equivalent substitutions, improvements etc. made within the spirit and principle of the embodiments of the present disclosure are intended to be included within the scope of protection of the present disclosure.

1. A text generation method, comprising:
obtaining an initial text;
performing information retrieval according to the initial text to obtain at least one piece of reference content;
performing information extraction on the at least one piece of reference content using a first language model to generate at least one piece of extracted information; and
in response to receiving a selection operation for the at least one piece of extracted information, generating a text outline according to selected extracted information, and performing text generation using a second language model according to the initial text and the text outline to obtain a target text.

2. The text generation method of claim 1, wherein the performing information retrieval according to the initial text comprises at least one of:
determining at least one first search term in the initial text, and performing the information retrieval according to the at least one first search term; or
determining first semantic information of the initial text, and performing the information retrieval according to the first semantic information.

3. The text generation method of claim 2, wherein the obtaining the at least one piece of reference content comprises:
obtaining at least one intermediate article according to a result of the information retrieval, and segmenting any intermediate article to obtain at least one segmented block;
determining a similarity between the at least one segmented block and the at least one first search term and/or the first semantic information, and screening the at least one segmented block according to the similarity; and
supplementing and combining results of the screening to obtain one piece of reference content.

4. The text generation method of claim 3, wherein the determining the similarity between the at least one segmented block and the at least one first search term and/or the first semantic information comprises:
determining vector representations of the at least one segmented block and the at least one first search term and/or the first semantic information, respectively, and determining cosine similarity between the vector representations to determine the similarity.

5. The text generation method of claim 1, wherein the obtaining the at least one piece of reference content comprises:
determining a source address of any piece of reference content, and generating a source identification for the any piece of reference content based on the source address.

6. The text generation method of claim 1, wherein after the generating the at least one piece of extracted information, the method further comprises:
receiving text information in response to not receiving the selection operation for the at least one piece of extracted information; and
generating a text outline based on the received text information.

7. The text generation method of claim 6, wherein the generating the text outline based on the received text information comprises:
determining at least one content point in the text information;
for any content point, determining at least one second search term and/or second semantic information based on the text information, and performing retrieval according to the at least one second search term and/or the second semantic information to obtain at least one relevant document; and
performing document screening and content cropping on the at least one relevant document to obtain specific content corresponding to the any content point, to generate the text outline based on specific content corresponding to the at least one content point.

8. The text generation method of claim 7, wherein the performing document screening on the at least one relevant document comprises:
sorting the at least one relevant document according to a similarity between the at least one relevant document and the at least one second search term and/or the second semantic information, and selecting documents according to a first set rule to perform the document screening.

9. The text generation method of claim 8, wherein the performing content cropping on the at least one relevant document comprises:
dividing any relevant document that passes the document screening according to a set length; and
sorting at least one divided segment according to a similarity between the at least one divided segment and the at least one second search term and/or the second semantic information, and selecting segments according to a second set rule to perform the content cropping.

10. The text generation method of claim 1, wherein the performing information extraction on the at least one piece of reference content using the first language model comprises:
using the first language model to perform content extraction of at least one set title on the at least one piece of reference content, and performing source identification on content extracted for each set title, to complete the information extraction.

11. The text generation method of claim 1, wherein the performing text generation using the second language model according to the initial text and the text outline comprises:
using the second language model to generate first content according to the initial text;
using the second language model to perform content generation according to at least one content item listed in the text outline, to form second content; and
combining the first content and the second content to complete the text generation.

12. A computer device, comprising a memory, a processor, and a computer program stored in the memory and executable by the processor, wherein the computer program, when executed by the processor, causes a text generation method to be implemented, wherein the text generation method comprises:
obtaining an initial text;
performing information retrieval according to the initial text to obtain at least one piece of reference content;
performing information extraction on the at least one piece of reference content using a first language model to generate at least one piece of extracted information; and
in response to receiving a selection operation for the at least one piece of extracted information, generating a text outline according to selected extracted information, and performing text generation using a second language model according to the initial text and the text outline to obtain a target text.

13. The computer device of claim 12, wherein the performing information retrieval according to the initial text comprises:
determining at least one first search term in the initial text, and performing the information retrieval according to the at least one first search term;
and/or
determining first semantic information of the initial text, and performing the information retrieval according to the first semantic information.

14. The computer device of claim 13, wherein the obtaining the at least one piece of reference content comprises:
obtaining at least one intermediate article according to a result of the information retrieval, and segmenting any intermediate article to obtain at least one segmented block;
determining a similarity between the at least one segmented block and the at least one first search term and/or the first semantic information, and screening the at least one segmented block according to the similarity; and
supplementing and combining results of the screening to obtain one piece of reference content.

15. The computer device of claim 14, wherein the determining the similarity between the at least one segmented block and the at least one first search term and/or the first semantic information comprises:
determining vector representations of the at least one segmented block and the at least one first search term and/or the first semantic information, respectively, and determining cosine similarity between the vector representations to determine the similarity.

16. The computer device of claim 12, wherein the obtaining the at least one piece of reference content comprises:
determining a source address of any piece of reference content, and generating a source identification for the any piece of reference content based on the source address.

17. The computer device of claim 12, wherein the text generation method further comprises: after the generating the at least one piece of extracted information,
receiving text information in response to not receiving the selection operation for the at least one piece of extracted information; and
generating a text outline based on the received text information.

18. The computer device of claim 17, wherein the generating the text outline based on the received text information comprises:
determining at least one content point in the text information;
for any content point, determining at least one second search term and/or second semantic information based on the text information, and performing retrieval according to the at least one second search term and/or the second semantic information to obtain at least one relevant document; and
performing document screening and content cropping on the at least one relevant document to obtain specific content corresponding to the any content point, to generate the text outline based on specific content corresponding to the at least one content point.

19. The computer device of claim 18, wherein the performing document screening on the at least one relevant document comprises:
sorting the at least one relevant document according to a similarity between the at least one relevant document and the at least one second search term and/or the second semantic information, and selecting documents according to a first set rule to perform the document screening.

20. A non-transitory computer-readable storage medium storing computer instructions, wherein the computer instructions are used to cause a computer to implement a text generation method, and the text generation method comprises:
obtaining an initial text;
performing information retrieval according to the initial text to obtain at least one piece of reference content;
performing information extraction on the at least one piece of reference content using a first language model to generate at least one piece of extracted information; and
in response to receiving a selection operation for the at least one piece of extracted information, generating a text outline according to selected extracted information, and performing text generation using a second language model according to the initial text and the text outline to obtain a target text.
